(19) United States
(12) Patent Application Publication
(10) Pub. No.: US 2022/0250501 A1
(43) Pub. Date: Aug. 11, 2022

(54) MANAGEMENT UNIT AND METHOD FOR MANAGING A PLURALITY OF MEASURING UNITS INVOLVED IN A CHARGING PROCESS

(71) Applicant: Siemens Aktiengesellschaft, München (DE)

(72) Inventor: Sebastian Bode, Ahlen (DE)

(21) Appl. No.: 17/628,597

(22) PCT Filed: Jul. 9, 2020
(86) PCT No.: PCT/EP2020/069330

§ 371 Date: Jan. 20, 2022

(30) Foreign Application Priority Data
Jul. 22, 2019 (DE) 10 2019 210 803.2

(51) Int. Cl. B60L 53/66; H02J 7/00; B60L 53/67

(52) U.S. Cl. CPC B60L 53/66; H02J 7/00034; H02J 2310/48; B60L 2250/20; B60L 53/67

(57) ABSTRACT

The disclosure relates to a management unit for managing a plurality of measurement units involved in a charging process, wherein distinguishable process identifiers are generated from a piece of authentication data of a user. A process identifier is transferred to a measurement unit involved in a charging process and integrated in a measurement data set from then on. Such a charging process also includes different phases of a charging process, wherein current branches joining or exiting are involved in each phase. Providing distinguishable process identifiers based on authentication data advantageously provides a unique allocation between a charging process and a user and a unique allocation of a plurality of measurement data sets generated by different measurement units to a charging process of the user, even if these change, join or exit during the charging process due to a charging power controlled in variable switching steps of the current branch.

The present patent document is a § 371 nationalization of PCT Application Serial No. PCT/EP2020/069330, filed Jul. 9, 2020, designating the United States, which is hereby incorporated by reference, and this patent document also claims the benefit of German Patent Application No. 10 2019 210 803.2, filed Jul. 22, 2019, which is also hereby incorporated by reference.

### TECHNICAL FIELD

The disclosure relates to a management unit and to a method for managing a plurality of measuring units involved in a charging process.

### BACKGROUND

Electric vehicles, or vehicles at least partially driven using electrical energy, have at least one rechargeable battery that needs to be regularly charged during ongoing operation of the electric vehicle. The electric vehicle is charged at a charging station—also known among experts as electric vehicle supply equipment or EVSE for short—which is connected to the electric vehicle via a charging cable or by wireless, inductive coupling.

Extended infrastructures frequently use so-called charging points, a charging point being characterized by remote components compared to a charging station. Individual components of the charging station, (e.g., converter branches or converter stages), are not necessarily associated with a specific charging point, but rather are associated with the charging points dynamically where possible. A charging point is also supplied with electrical energy from multiple converter branches or converter stages, depending on the charging power required.

Increasing expansion of a charging infrastructure including multiple charging points is resulting in greater attention being paid to providing tamper-proof, traceable, and verifiable billing for the electrical energy that is transferred. Calibrated measuring devices for measuring the electrical energy transferred to the electric vehicle or, in general, to an energy sink form a basis for this. The requirements for such measuring devices are also characterized by specifications concerning calibration law.

It is currently possible to observe a development towards innovative measuring devices that have not only their very own task—measuring electrical energy—but also extended functions for creating a measurement dataset. In such a measurement dataset, there is provision for an identification datum to be associated with the measured electrical energy, for example. A new measuring device of this type is therefore also referred to by the term measuring unit below. The development of modern measuring units is characterized by the requirement to provide measured values with an identification datum for the electrical energy drawn by the energy sink.

At public charging stations available to a user for charging their electric vehicle (e.g., the energy sink), it is primarily necessary for the respective user to be identified for the purpose of billing for the electrical power drawn. This requirement is more extensive than requirements for household energy meters or “electricity meters”, for which only the energy sink, (e.g., an entire household), needs to be identified. In the case of household energy meters, the energy sink is normally identified by way of a meter number. There is currently no technical provision for more extensive detailing of a user in the case of household energy meters, and this is also not necessary for billing. At public charging stations, however, the respective user needs to be identified for the purpose of billing for the electrical power drawn.

At present, public charging stations available to a user for charging their electric vehicle, the user is identified and authenticated, (e.g., using a card). The electrical power drawn is then merely measured by a present measuring device, while measurement data are associated with the user, as required for billing purposes, by the charging station. The result of this association is then a total measurement dataset, in the case of which the measurement data pertaining to the electrical power drawn are listed in detail and then associated with an authenticated user. Although measuring devices that automatically form a total measurement dataset are also known from the prior art, the association is made by the charging station by virtue of it providing the data of the user beforehand, (e.g., at the beginning), or no later than immediately before the end of measurement.

In other words, present public charging stations require a central controller in which identification of the user, authentication of the user and creation of a billing dataset are implemented. With a forecastable increasing number of public charging stations, it appears to be desirable to relocate some of these implementations from the central controller of the charging station to a remote instance or to distributed components inside or outside the charging station or the charging infrastructure and thus to reduce the technical complexity for developing and operating the central controller of present charging infrastructures.

Furthermore, future charging infrastructures having multiple charging points even include more than one measuring unit per charging point, since one measuring unit per converter branch, or converter stage, is intended in future for measuring the electrical energy delivered from multiple converter branches. Since the measurement datasets captured by the measuring units are relevant to billing, it is necessary to provide that unique association with a user is possible.

This requirement proves to be technically difficult, however, for several reasons. First, it is the case that the users at the charging points regularly change. It is therefore necessary to guarantee a unique association between a charging process and a user. Second, this association is guaranteed uniquely even if multiple measuring units may be associated with a charging process supplied with power from multiple converter branches. In particular, it is necessary to guarantee that the association is undone if supplied energy from a converter branch is switched over from a charging process for a first user to a charging process for a second user.

Association of an authenticated user with multiple measurement datasets from individual converter branches meets with security reservations, however. In future charging infrastructures, technical, and/or organizational measures need to be taken instead in order to prevent such multiple association of an authenticated user.

### SUMMARY AND DESCRIPTION

It is an object of the disclosure to provide means for managing a plurality of measuring units involved in a charging process that guarantee that a total measurement dataset associable with a user is created from multiple measurement datasets produced for a charging process.

The scope of the present disclosure is defined solely by the appended claims and is not affected to any degree by the statements within this summary. The present embodiments may obviate one or more of the drawbacks or limitations in the related art.

The management unit for managing a plurality of measuring units involved in a charging process includes: an authentication module for authenticating a user on the basis of at least one authentication datum associated with the user; a requirement receiving module for receiving a requirement request message that is transmitted by one of the plurality of measuring units involved in the charging process and identifies said measuring unit by a measuring unit identifier; a process identifier module for producing a process identifier that is created on the basis of the authentication datum and may be distinguished for each requirement request message; an interface module for transmitting the process identifier to the measuring unit determined by the measuring unit identifier, wherein the interface module is further configured to receive at least one measurement dataset containing the process identifier and at least one measurement datum; and an association module for creating a total measurement dataset, associable with the user, by merging at least one measurement dataset collected for at least one process identifier.

The management unit provides for generating multiple distinguishable process identifiers from an authentication datum of a user. A respective process identifier is transferred to a respective measuring unit involved in a charging process and from then on is integrated in a measurement dataset by said measuring unit. Such a charging process in particular also includes different phases of a charging process, with joining or leaving current paths, for example converter branches, being involved in each phase, which themselves include measuring units joining or leaving the charging process. For a measuring unit joining the charging process, there is provision for said measuring unit to transmit a requirement request message to the management unit, from which it receives in response a process identifier that is created on the basis of the authentication datum and may be distinguished for each requirement request message. Transmission of the requirement request message to the management unit is either triggered by the measuring unit itself or requested by the management unit. The first-mentioned case corresponds to “pushing”, which involves the measuring unit as data supplier assessing a requirement in the form of events or data changes and transmitting a requirement request message to the management unit if necessary. The second-mentioned case corresponds to “polling”, which involves the management unit monitoring the requirement using cyclic or event-controlled queries, (e.g., in the form of a protocol for querying the managed measuring units, which is not discussed in more detail here), and requesting transmission of a requirement request message by one or more measuring units.

The provision of distinguishable process identifiers on the basis of the authentication datum advantageously guarantees a unique association between a charging process and a user. Furthermore, the provision of distinguishable process identifiers guarantees a unique association of multiple measurement datasets generated by different measuring units with a charging process of the user, even if said measuring units change, join or leave during the charging process on the basis of a charging power controlled in variable switching stages of the current paths.

The unique alternate association of the authentication datum of an authenticated user with multiple distinguishable process identifiers advantageously avoids repeated association of the authentication datum and is therefore also not subject to security reservations in future implementations.

### BRIEF DESCRIPTION OF THE DRAWINGS

Further exemplary embodiments and advantages of the disclosure are explained in more detail below with the aid of the drawing.

FIG. 1 depicts a schematic depiction of a charging infrastructure communicatively connected to an embodiment of a management unit.

### DETAILED DESCRIPTION

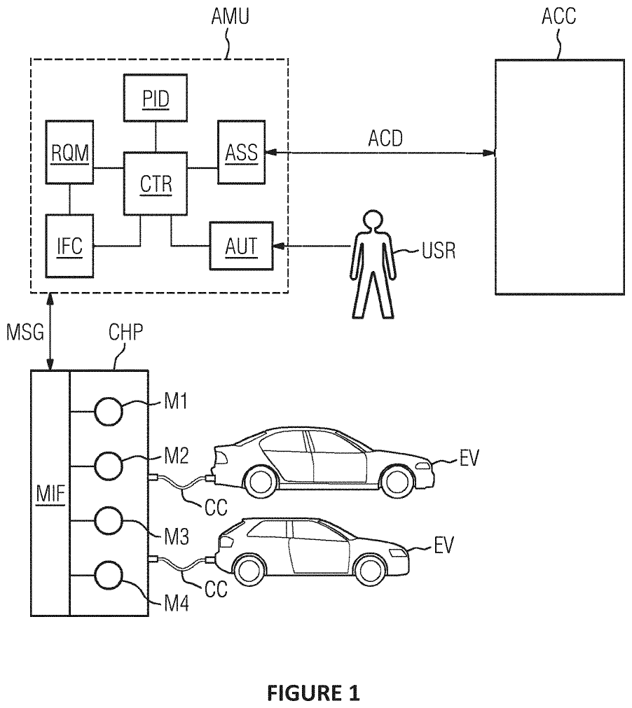

FIG. 1 depicts a charging infrastructure CHP that is used for charging electric vehicles EV, or at least partially electrically driven vehicles. To this end, the charging infrastructure CHP includes two charging points, to which the electric vehicles EV may be connected by way of an appropriate charging cable CC. The charging infrastructure CHP normally includes a plurality of converter branches (not shown). Respective converter branches are used to convert a three-phase AC current into DC current, for example. This DC current may then be used to charge the electrical energy stores of the electric vehicles EV at the respective charging points.

In addition, the charging infrastructure CHP includes a plurality of measuring units M1, M2, M3, M4, which measure an electrical energy delivered in the individual converter branches or an electrical energy delivered on the charging cable, for example. Furthermore, respective measuring units M1, M2, M3, M4 may determine an electrical energy that is supplied, e.g., to a respective converter branch from a power supply grid. Further measuring units M1, M2, M3, M4 may be provided for measuring an electrical energy that is supplied to or taken from the charging cable CC. In one example, the measuring unit M1, M2, M3, M4 may be located in the charging infrastructure CHP. In another example, the measuring unit may be located close to the vehicle, for example, on the plug or at the end of the charging cable CC.

Incidentally, the measuring units M1, M2, M3, M4 are not restricted to measuring electrical energy. Depending on implementation, measuring units M1, M2, M3, M4 may also be used for measuring a voltage, an electric current, an electrical power, an electrical reactive power, an electrical resistance, or a temperature. Furthermore, measuring units M1, M2, M3, M4 may also be used for determining a time or for measuring a period of time.

The measuring units M1, M2, M3, M4 may include a measuring module (not shown) for measuring at least one measured variable and for determining at least one measurement datum from the measured variable, and also an interface module (not shown). The interface module in a measuring unit M1, M2, M3, M4 interacts with an interface MIF of the charging infrastructure CHP bidirectionally for the purpose of interchanging messages MSG. The interface MIF of the charging infrastructure CHP is used to interchange the messages MSG with an interface module IFC of the management unit AMU in a cryptographically secure manner. The physical extent of this interface MIF is not restricted. The interface MIF used may be a local or global data network, for example, which connects a plurality of spatially distributed charging infrastructures in a known packet-oriented manner. The interface MIF may also include multiple charging infrastructure units, in contrast to the arrangement shown in FIG. 1.

An embodiment of the management unit AMU for managing the plurality of measuring units M1, M2, M3, M4 involved in a charging process includes an authentication module AUT for authenticating a user USR on the basis of at least one authentication datum associated with the user. The management unit AMU furthermore includes a requirement receiving module RQM for receiving a requirement request message that is transmitted by one of the plurality of measuring units M1, M2, M3, M4 involved in the charging process and identifies said measuring unit by a measuring unit identifier, and a process identifier module PID for producing a process identifier that is created on the basis of the authentication datum and may be distinguished for each requirement request message.

The interface module IFC of the management unit AMU is used to transmit a process identifier to the measuring unit M1, M2, M3, M4 determined by the measuring unit identifier, for example. Furthermore, the interface module IFC is designed to receive the measurement datasets from the measuring units M1, M2, M3, M4. These measurement datasets contain the respective process identifier and at least one measurement datum and may be cryptographically secure.

The management unit AMU furthermore includes an association module ASS for creating a total measurement dataset, associable with the user, by merging at least one measurement dataset collected for at least one process identifier.

According to one embodiment, the aforementioned modules IFC, RQM, PID, ASS, AUT of the management unit AMU are in the form of separate hardware modules that communicate with a central controller CTR within the management unit AMU. In alternative embodiments, some or all of the aforementioned modules IFC, RQM, PID, ASS, AUT are at least in part in the form of software modules, the program code of which is loaded and executed in a central controller CTR of the management unit AMU. The aforementioned modules IFC, RQM, PID, ASS, AUT may be executed as independent processes on a central server or as distributed web services in a distributed environment, or cloud.

The method is explained more thoroughly below in the embodiment depicted here. The first act provides for authentication of a user USR on the basis of at least one authentication datum associated with the user USR. Various embodiments are conceivable in this case. By way of example, an authentication datum is determined from use of a value card in conjunction with entry of a personal identification number, PIN for short, or from a mobile terminal of the user USR in conjunction with an application executed on the mobile terminal. Following confirmation of identity by the authentication, (which optionally entails additional authentication features such as secret number entry, registration of physical features such as facial recognition, etc.), the user USR is optionally authorized for authentication purposes, that is to say that it is ascertained whether the identified user USR has permission for use, followed by selection and charging approval for the charging point desired by the user USR. Authorization may be accomplished by involving a remotely queried user account (not shown) with a check on the permission or credentials of the user USR.

Before the start of or during the charging process, there is provision at the requirement receiving module RQM for reception of a requirement request message transmitted by one or more of the measuring units M1, M2, M3, M4 involved in the charging process. By way of example, the measuring units M1, M2, M3, M4 involved in the charging process transmit a requirement request message to the management unit AMU when an event occurs for which the measuring unit M1, M2, M3, M4 is involved in a charging process. Such requirement request messages are interchanged as packet-oriented messages MSG between the interface MIF of the charging infrastructure CHP and the interface module IFC of the management unit AMU. The measuring unit M1, M2, M3, M4 is identified in the requirement request message by an individual measuring unit identifier. A message of the same kind as the requirement request message is transmitted even if an event occurs for which the involvement of the measuring unit M1, M2, M3, M4 in a charging process is stopped or terminated.

On receiving a requirement request message, the management unit AMU then produces a distinguishable process identifier by the process identifier module PID. With a certain degree of similarity to the authentication datum of the user USR, this process identifier also corresponds to an authentication datum, or identification datum, but with the difference that multiple different—that is to say also distinguishable—process identifiers are now created for a user identity, which process identifiers may be associated with the user USR again at any time owing to the fact that the process identifiers were produced on the basis of the authentication datum. However, the different nature of the process identifiers means that repeated association of an authentication datum is advantageously avoided.

A measuring unit M1, M2, M3, M4 involved in the charging process receives in response to the aforementioned requirement request message a process identifier transmitted by the management unit AMU, which process identifier may likewise be contained in a message MSG. This message MSG containing the process identifier is sent by the management unit AMU to the measuring unit M1, M2, M3, M4 determined by the measuring unit identifier of the previously received requirement request message.

A measuring unit M1, M2, M3, M4 involved in the charging process now transmits—at regular intervals of time or in event-based fashion—a measurement dataset to the management unit AMU referring to this process identifier. The measurement dataset contains not only this process identifier but also at least one measurement datum.

Following termination of the charging process, the association module ASS finally creates a total measurement dataset ACD, associable with the user USR, by merging all measurement datasets collected for the process identifier. The total measurement dataset ACD is transmitted to a billing center ACC for the purpose of billing for the electrical energy. The total measurement dataset ACD is sent either (as indicated in FIG. 1) via a dedicated external interface of the association module ASS or via the interface module IFC. In both cases, the transmission of the total measurement dataset ACD and a further data interchange with the billing center ACC take place by way of a cryptographically secure message interchange. The total measurement dataset ACD may be provided with a timestamp and then digitally signed. For the purpose of signature, e.g., the association module ASS is used to compute a value for the total measurement dataset ACD using an appropriate signature key, the value also being able to be referred to as a signature or digital signature. The signature allows a public verification key to be used to check the authorship and integrity of the total measurement dataset ACD.

According to one configuration, the management unit includes a time server by which the managed measuring units M1, M2, M3, M4 request a current time.

In a further configuration, there is provision for the producing of the process identifier to be started in the course of authentication of the user USR already. Such a measure is advantageous for example if the user initiates his authentication, (e.g., by scanning a permission card or credit card), in order to enter a parking area. The process identifier may then be both used for billing for his parking time and reused for a charging process—started after entering the parking area. To record the parking time, it is advantageous if a timer for the process identifier produced is started in the course of authentication. The value of the timer that is read off, (e.g., on exit then represents the parking time), which may be billed for in addition to the electrical energy consumed for the charging process.

An appropriate example of application of this embodiment of the method is described below. A user USR drives his electric vehicle EV into a parking garage. To open the barrier, the user needs to authenticate themselves. The authentication information is transmitted to the management unit AMU. The management unit AMU then starts a time measurement. The user USR drives to a vacant charging point and connects his vehicle EV to a charging point. A controller associated with the charging point ascertains from the power requested by the vehicle EV, or the requested current, that three converter stages would be needed in order to provide the requested power, or the requested current, but there are currently only two converter stages available. The management unit AMU is informed by appropriate requirement request messages and produces two process identifiers, which are transmitted to the measuring units associated with the two power stages. The charging process is then started. The management unit AMU starts a further time measurement on the basis of the charging process or forms an intermediate value for the first time measurement, which is already running and maintained.

During the charging process, a further third converter stage becomes free. The power delivered, or the current delivered, is increased using the third converter stage. To this end, the management unit AMU transmits a further process identifier to a measuring unit associated with the third phase of the third converter stage, terminates the second time measurement and starts a further, third time measurement.

As time progresses, the electric vehicle would now need only a smaller charging current on account of an adequate state of charge having been reached.

When this occurs, the third phase is removed from the charging process again. Accordingly, the measurement process for the measuring unit associated with the third phase of the third converter stage is terminated. The measuring unit associated with the third phase transmits a measurement dataset to the management unit AMU and optionally indicates that the measurement process is terminated. The management unit AMU again starts a new time measurement. The same happens if, on the basis of a priority charging process of another user, a phase or a power stage is taken away from the charging process of the user USR under consideration here and is supplied to the other user for his priority charging process.

The charging process for the user USR still under consideration here is continued at lower charging power. The management unit AMU optionally receives measurement datasets from measuring units that are no longer needed, sends new or existing process identifiers to additional or freshly involved measuring units and starts a new time measurement for each event, until the user USR finally leaves the parking garage.

All measurement datasets are combined by the association module ASS into a total measurement dataset, provided with a timestamp, signed and provided for tariffing.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A management unit for managing a plurality of measuring units involved in a charging process, the management unit comprising:
an authentication module configured to authenticate a user based on at least one authentication datum associated with the user;
a requirement receiving module configured to receive a requirement request message transmitted by a measuring unit of the plurality of measuring units involved in the charging process and identify the measuring unit by a measuring unit identifier;
a process identifier module configured to produce a process identifier that is created based on the authentication datum and is configured to be distinguished for each requirement request message;
an interface module configured to transmit the process identifier to the measuring unit determined by the measuring unit identifier, wherein the interface module is further configured to receive at least one measurement dataset containing the process identifier and at least one measurement datum; and
an association module configured to create a total measurement dataset, associable with the user, by merging at least one measurement dataset collected for at least one process identifier.

2. The management unit of claim 1, wherein the measurement dataset comprises an identification datum of the measuring unit, time information associated with the measurement datum, or a combination thereof.

3. The management unit of claim 2, wherein the interface module and/or the association module are configured to cryptographically secure interchange of messages or the total measurement dataset.

4. The management unit of claim 3, wherein the interface module and/or the association module are further configured to check a signature or allocate a signature in payload data of the messages or the total measurement dataset.

5. A method for managing a plurality of measuring units involved in a charging process, the method comprising:
authenticating a user, by a management unit, based on at least one authentication datum associated with the user;
receiving at the management unit a requirement request message that is transmitted by a measuring unit of the plurality of measuring units involved in the charging process, wherein the requirement request message contains a measuring unit identifier that identifies the transmitting measuring unit;
producing, by the management unit, a process identifier that is created based on the authentication datum, wherein the process identifier is configured to be distinguished for each requirement request message;
transmitting the process identifier to the measuring unit determined by the measuring unit identifier;
receiving at least one measurement dataset containing the process identifier and at least one measurement datum; and
creating a total measurement dataset associable with the user by merging the at least one measurement dataset collected for at least one process identifier.

6. The method of claim 5, wherein the producing of the process identifier takes place in course of the authenticating of the user.

7. The method of claim 6, wherein a timer for the process identifier produced is started in the course of the authenticating of the user.

8. The method of claim 5, wherein a timer for the process identifier produced is started in course of the authenticating of the user.

9. The management unit of claim 1, wherein the interface module and/or the association module are configured to cryptographically secure interchange of messages or the total measurement dataset.

10. The management unit of claim 9, wherein the interface module and/or the association module are further configured to check a signature or allocate a signature in payload data of the messages or the total measurement dataset.

11. The management unit of claim 1, wherein the interface module and/or the association module are configured to check a signature or allocate a signature in payload data of the messages or the total measurement dataset.
